(19) United States
(12) Patent Application Publication
(10) Pub. No.: US 2011/0083046 A1
(43) Pub. Date: Apr. 7, 2011

(54) HIGH AVAILABILITY OPERATOR GROUPINGS FOR STREAM PROCESSING APPLICATIONS

(75) Inventors: HENRIQUE ANDRADE, Hawthorne, NY (US); Louis R. Degenaro, Hawthorne, NY (US); Bugra Gedik, Hawthorne, NY (US); Gabriels Jacques da Silva, Champaign, IL (US); Vibhore Kumar, Hawthorne, NY (US); Kun-Lung Wu, Hawthorne, NY (US)

(73) Assignee: International Business Machines Corporation, Armonk, NY (US)

(21) Appl. No.: 12/575,378

(22) Filed: Oct. 7, 2009

(51) Int. Cl. G06F 11/30; G06F 11/00

(52) U.S. Cl. 714/47.1; 714/E11.024

(57) ABSTRACT

One embodiment of a method for providing failure recovery for an application that processes stream data includes providing a plurality of operators, each of the operators comprising a software element that performs an operation on the stream data, creating one or more groups, each more groups including a subset of the operators, assigning a policy to each of the groups, the policy comprising a definition of how the subset of the operators will function in the event of a failure, and enforcing the policy through one or more control elements that are interconnected with the operators.

### REFERENCE TO GOVERNMENT FUNDING

This invention was made with Government support under Contract No. H98230-07-C-0383, awarded by the United States Department of Defense. The Government has certain rights in this invention.

### BACKGROUND OF THE INVENTION

The present invention relates generally to providing fault tolerance for component-based applications, and relates more specifically to high availability techniques for stream processing applications, a particular type of component-based application.

Stream processing is a paradigm to analyze continuous data streams (e.g., audio, video, sensor readings, and business data). An example of a stream processing system is a system running the INFOSPHERE STREAMS middleware commercially from International Business Machines Corporation of Armonk, N.Y., which will run applications written in the SPADE programming language. Developers build streaming applications as data-flow graphs, which comprise a set of operators interconnected by streams. These operators are software elements that implement the analytics that will process the incoming data streams. The application generally runs non-stop, since data sources (e.g., sensors) constantly produce new information. Fault tolerant techniques of varying strictness are generally used to ensure that stream processing applications continue to generate semantically correct results even in the presence of failure.

For instance, sensor-based patient monitoring applications require rigorous fault tolerance, since the unavailability of patient data may lead to catastrophic results. By contrast, an application that discovers caller/callee pairs by data mining a set of Voice over Internet Protocol (VoIP) streams may still be able to infer the caller/callee pairs despite packet loss or user disconnections (although with less confidence). The second type of application is referred to as “partial fault tolerant.”

An application generally uses extra resources (e.g., memory, disk, network, etc.) in order to maintain additional copies of the application state (e.g., replicas). This allows the application to recover from a failure and to be highly available. However, a strict fault-tolerance technique for the entire application may not be required, as it would tend to lead to the waste of resources. More importantly, a strict fault-tolerance technique may not be the strategy that best fits a particular stream processing application.

### SUMMARY OF THE INVENTION

One embodiment of a method for providing failure recovery for an application that processes stream data includes providing a plurality of operators, each of the operators comprising a software element that performs an operation on the stream data, creating one or more groups, each more groups including a subset of the operators, assigning a policy to each of the groups, the policy comprising a definition of how the subset of the operators will function in the event of a failure, and enforcing the policy through one or more control elements that are interconnected with the operators.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method for providing fault tolerance for a stream processing application, according to the present invention;

FIGS. 2A and 2B are block diagrams illustrating a first embodiment of a group of operators, according to the present invention;

FIG. 3 is a flow diagram illustrating one embodiment of a method for detecting a failure of a processing element in a high availability group of processing elements, according to the present invention;

FIGS. 4A and 4B are block diagrams illustrating a second embodiment of a group of operators, according to the present invention;

FIGS. 5A and 5B are block diagrams illustrating a third embodiment of a group of operators, according to the present invention;

FIG. 6 is a high-level block diagram of the failure recovery method that is implemented using a general purpose computing device; and

FIG. 7 is a block diagram illustrating an exemplary stream processing application, according to the present invention.

### DETAILED DESCRIPTION

In one embodiment, fault tolerance in accordance with the present invention is implemented by allowing different operators to specify different high-availability requirements. “High availability” refers to the ability of an application to continue processing streams of data (for both consumption and production) in the event of a failure and without interruption. High availability is often implemented through replication of an application, including all of its operators (and the processing elements making up the operators). However, replication of the entire application consumes a great deal of resources, which may be undesirable when resources are limited. Since each operator or processing element in an application processes data in a different way, each operator or processing element may have different availability requirements. Embodiments of the invention take advantage of this fact to provide techniques for fault tolerance that do not require the replication of the entire application.

Embodiments of the present invention may be deployed using the SPADE programming language and within the context of the INFOSPHERE STREAMS distributed stream processing middleware application, commercially available from International Business Machines Corporation of Armonk, N.Y. Although embodiments of the invention may be discussed within the exemplary context of the INFOSPHERE STREAMS middleware application and the SPADE programming language framework, however, those skilled in the art will appreciate that the concepts of the present invention may be advantageously implemented in accordance with substantially any type of stream processing framework and with any programming language.

The INFOSPHERE STREAMS middleware application is non-transactional, since it does not have atomicity or durability guarantees. This is typical in stream processing applications, which run continuously and produce results quickly. Within the context of the INFOSPHERE STREAMS middleware application, independent executions of an application with the same input may generate different outputs. There are two main reasons for this non-determinism. First, stream operators often consume data from more than one source. If the data transport subsystem does not enforce message ordering across data coming from different sources, then there is no guarantee in terms if which message an operator will consume first. Second, stream operators can use time-based windows. Some stream operators (e.g., aggregate and join operators) produce output based on data that has been received within specified window boundaries. For example, if a programmer declares a window that accumulates data over twenty seconds, there is no guarantee that two different executions of the stream processing application will receive the same amount of data in the defined interval of twenty seconds.

The INFOSPHERE STREAMS middleware application deploys each stream processing application as a job. A job comprises multiple processing elements, which are containers for the stream operators that make up the stream processing application's data-flow graph. A processing element hosts one or more stream operators. To execute a job, the user contacts the job manager, which is responsible for dispatching the processing elements to remote nodes. The job manager in turn contacts a resource manager to check for available nodes. Then, the job manager contacts master node controllers at the remote nodes, which instantiate the processing elements locally. Once the processing elements are running, a stream processing core if responsible for deploying the stream connections and transporting data between processing elements.

The INFOSPHERE STREAMS middleware application has many self-healing features, and the job manager plays a fundamental role in many of these. In addition to dispatching processing elements, the job manager also monitors the life cycles of these processing elements. Specifically, the job manager receives information from each master node controller, which monitors which processing elements are alive at its respective node. The job manager monitors the node controllers and the processing elements by exchanging heartbeat messages. If a processing element fails, the job manager detects the failure and compensates for the failed processing element in accordance with a predefined policy, as discussed in greater detail below. A processing element may fail (i.e., stop executing its operations or responding to other system processes) for any one or more of several reasons, including, but not limited to: a heisenbug (i.e., a computer bug that disappears or alters its characteristics when an attempt is made to study it) in the processing element code (e.g., a timing error), a node failure (e.g., a power outage), an operating system kernel failure (e.g., a device driver crashes and forces a machine reboot), a transient hardware fault (e.g., a memory error corrupts an application variable and causes the stream processing application to crash), or a network failure (e.g., the network cable gets disconnected, and no other node can send data to the processing element).

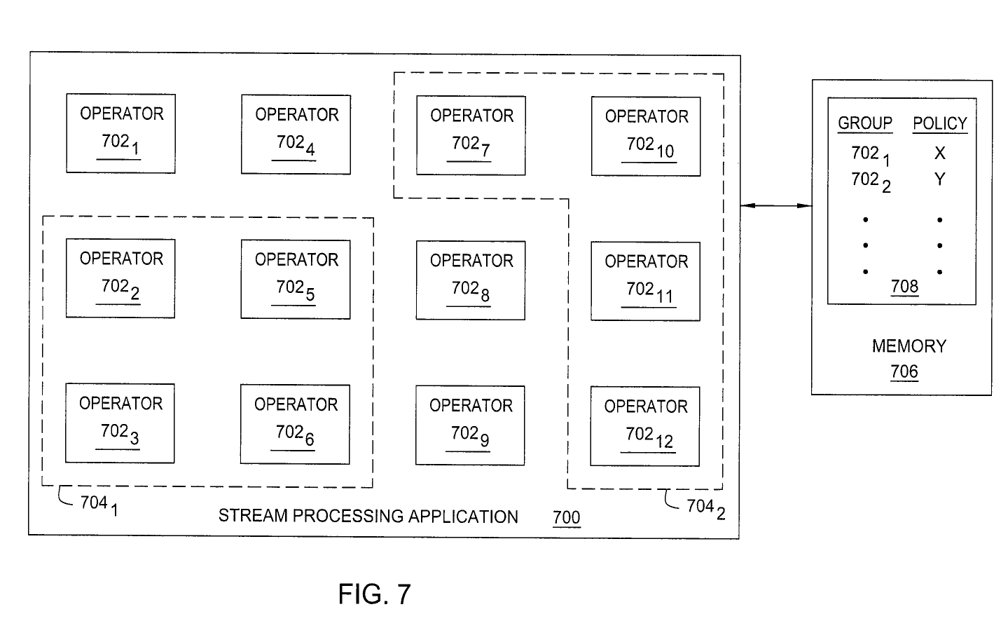

FIG. 7 is a block diagram illustrating an exemplary stream processing application 700, according to the present invention. As illustrated, the stream processing application 700 comprises a plurality of operators 702₁-702₁₂ (hereinafter collectively referred to as “operators 702”). For ease of explanation, the details of the operators 702 and their interconnections are not illustrated. Although the stream processing application 700 is depicted as having twelve operators 702, it is appreciated that the present invention has application in stream processing applications comprising any number of operators.

In accordance with embodiments of the present invention, at least some of the operators 702 may be grouped together into groups 704₁-704₂ (hereinafter collectively referred to as “groups 704”). Although the stream processing application 700 is depicted as having two groups 704, it is appreciated that the operators 702 may be grouped into any number of groups.

Each of the groups 704 is in turn associated with a high availability policy that comprises a definition of how the operators 702 in a given group 704 will function in the event of a failure. For example, as discussed in further detail below, the high availability policy for a given group 704 may dictate that a certain number of replicas be produced for each operator 702 in the group 704. A memory 706 that is coupled to the stream processing application 700 may store a data structure 708 that defines the policy associated with each group 704.

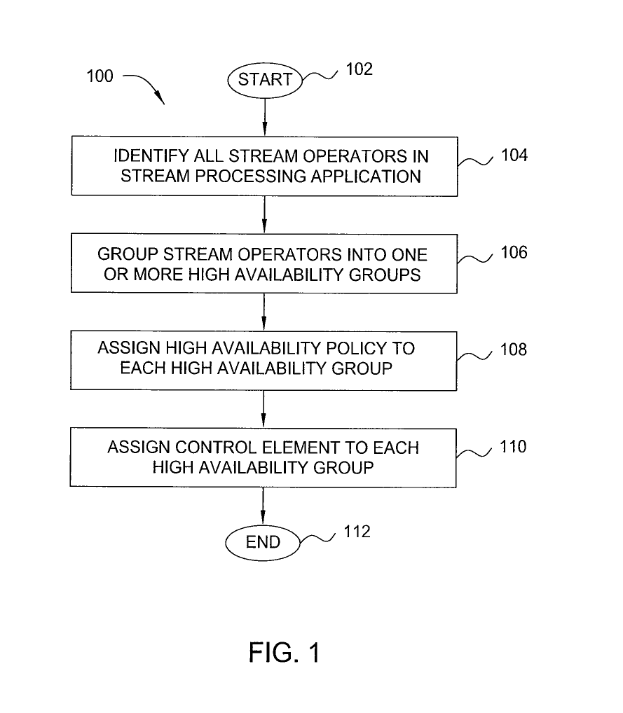

FIG. 1 is a flow diagram illustrating one embodiment of a method 100 for providing fault tolerance for a stream processing application, according to the present invention. Specifically, the method 100 allows different high availability policies to be defined for different parts of the application, as discussed in further detail below.

The method 100 is initialized at step 102 and proceeds to step 104, where all stream operators in the stream processing application are identified. The method 100 then proceeds to step 106, where the stream operators are grouped into one or more high availability groups. In one embodiment, each high availability group includes at least one stream operator. For example, if the stream processing application contains fifteen stream operators, the application developer may create a first high availability group including two of the stream operators and a second high availability group including two other stream operators.

In step 108, each high availability group is assigned a high availability policy, which may differ from group to group. A high availability policy specifies how the stream operators in the associated high availability group will function in the event of a failure. For example, a high availability policy may specify how many replicas to make of each stream operator in the associated high availability group and/or the mechanisms for fault detection and recovery to be used by the stream operators in the associated high availability group.

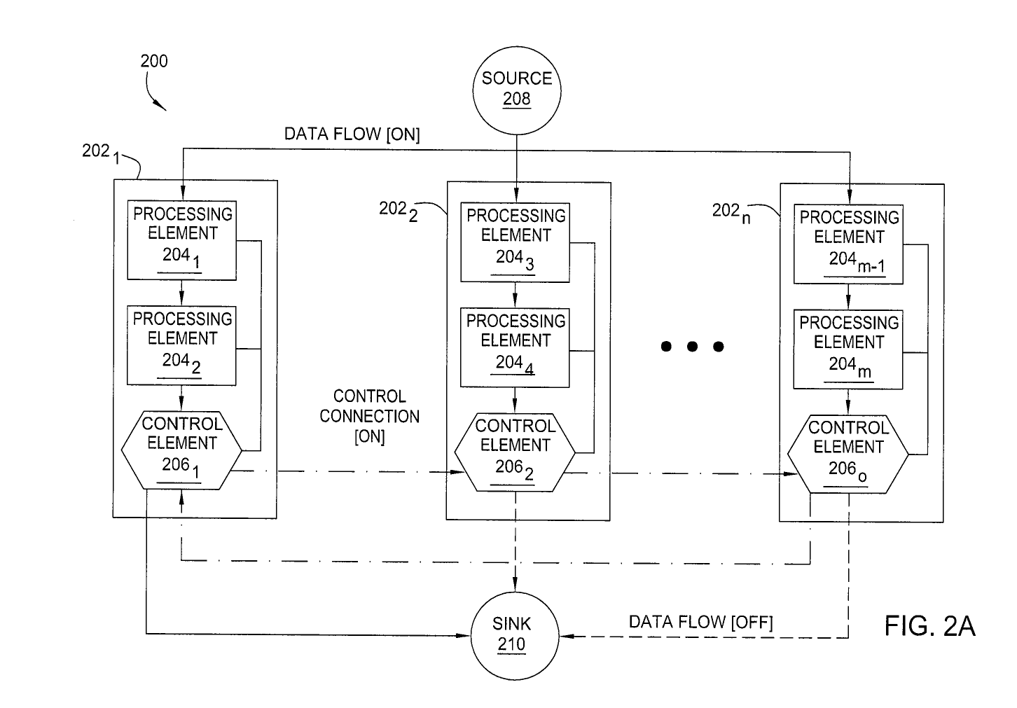

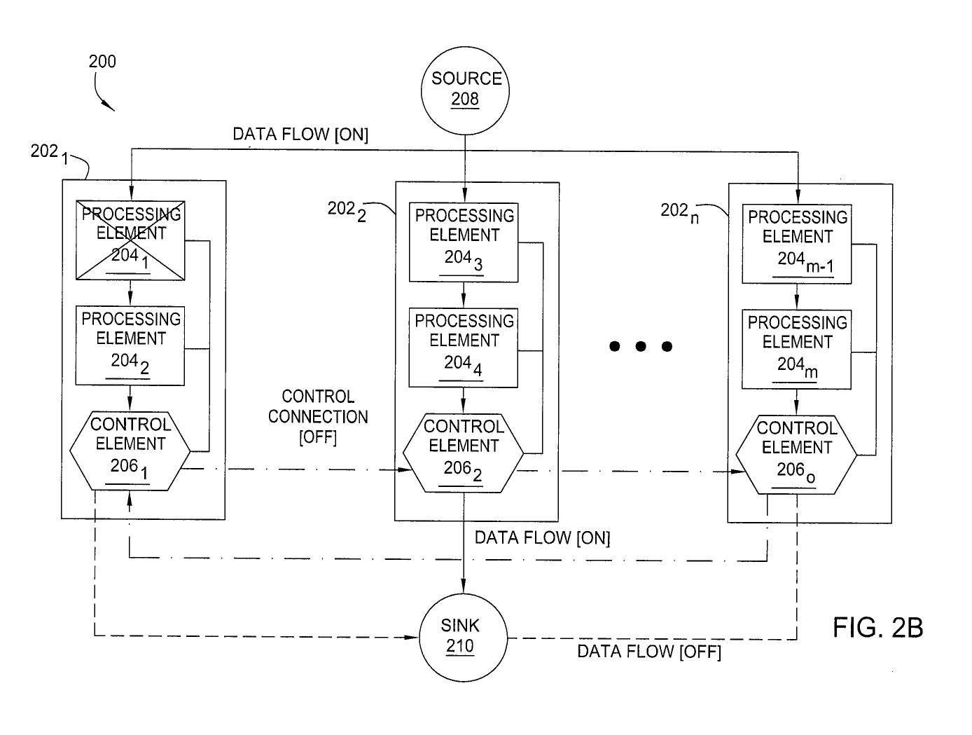

In step 110, at least one control element is assigned to each high availability group. A control element enforces the high availability policies for each replica of one high availability group by executing fault detection and recovery routines. In one embodiment, a single control element is shared by multiple replicas of one high availability group. In another embodiment, each replica of a high availability group is assigned at least one primary control element and at least one secondary or backup control element that performs fault detection and recovery in the event of a failure at the primary control element. The control elements are interconnected with the processing elements in the associated high availability group. The interconnection of the control elements with the processing elements can be achieved in any one of a number of ways, as described in further detail below in connection with FIGS. 2A-5B.

The method 100 terminates in step 112.

FIGS. 2A and 2B are block diagrams illustrating a first embodiment of a group 200 of operators, according to the present invention. Specifically, the group 200 of operators comprises a plurality of replicas 202₁-202ₙ (hereinafter collectively referred to as “replicas 202”) of the same set of operators. Thus, the replicated operator has been assigned to a high availability group as described above. As illustrated, the replicas 202 are arranged in this embodiment in a daisy chain configuration.

Each of the replicas 202 is connected to a common source 208 and a common sink 210. As illustrated, the replicas 202 are substantially identical: each replica 202 comprises an identical number of processing elements 204₁-204ₘ (hereinafter collectively referred to as “processing elements 204”) and a control element 206₁-206ₒ (hereinafter collectively referred to as “control elements 206”). As illustrated in FIG. 2A, the first replica 202₁ is initially active, while the other replicas 202₂-202ₙ are inactive. Thus, data flow from the first replica 202₁ to the sink 210 is set to ON, while data flow from the other replicas 202₂-202ₙ to the sink 210 is set to OFF. In addition, the control element 206₁ in the first replica 202₁ communicates with and controls the control element 206₂ in the second replica 202₂ (as illustrated by the control connection that is set to ON). Thus, the control element 206₁ in the first replica 202₁ serves as the group's primary control element, while the control element 206₂ in the second replica 202₂ serves as the secondary or backup control element.

FIG. 2B illustrates the operation of the secondary control element. Specifically, FIG. 2B illustrates what happens when a processing element 204 in the active replica fails. As illustrated, processing element 204₁ in the first replica 202₁ has failed. As a result, data flow from the first replica 202₁ terminates (the first replica 202₁ becomes inactive), and the control element 206₁ in the first replica detects this failure. The control connection between the control element 206₁ in the first replica 202₁ and the control element 206₂ in the second replica 202₂ switches to OFF, and the second replica 202₂ becomes the active replica for the group 200. Thus, data flow from the second replica 202₂ to the sink 210 is set to ON, while data flow from the first replica 202₁ is now set to OFF. Thus, the control element 206₂ in the second replica 202₂ now serves as the group's primary control element, while the control element 206₁ in the first replica 202₁ wills serve as the secondary or backup control element once the failed processing element 204₁ is restored.

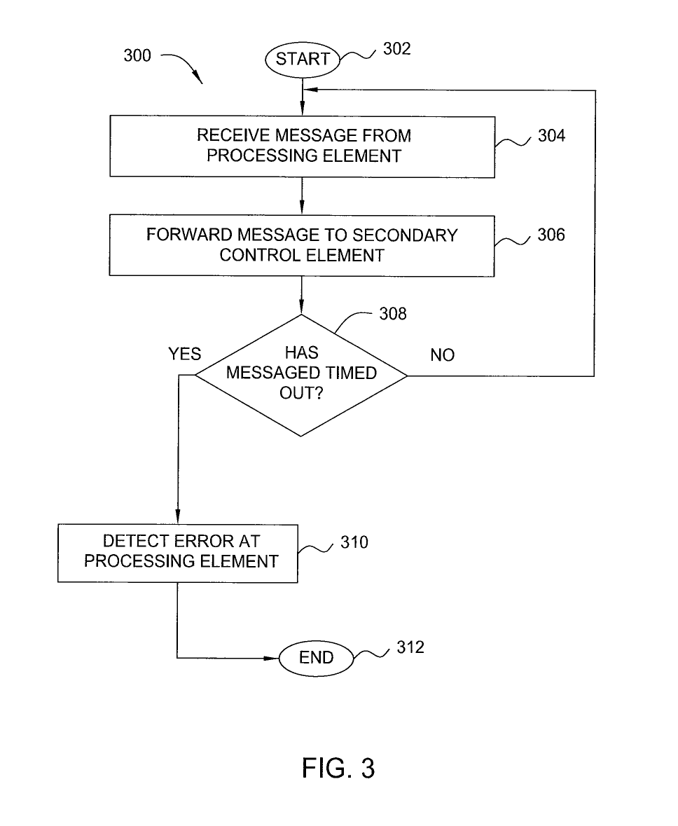

FIG. 3 is a flow diagram illustrating one embodiment of a method 300 for detecting a failure of a processing element in a high availability group of processing elements, according to the present invention. The method 300 may be implemented, for example, at a control element in a stream processing application, such as the control elements 202 illustrated in FIGS. 2A and 2B. As discussed above, a high-availability group may be associated with both a primary control element and a backup control element; in such an embodiment, the method 300 is implemented at both the primary control element and the secondary control element.

The method 300 is initialized at step 302 and proceeds to step 304, where the control element 300 receives a message from a processing element in a high availability group of processing elements.

In optional step 306 (illustrated in phantom), the control element 300 forwards the message to the secondary control element. Step 306 is implemented when the control element at which the method 300 is executed is a primary control element.

In step 308, the control element 300 determines whether the message has timed out. In one embodiment, the control element expects to receive messages from the processing element in accordance with a predefined or expected interval of time (e.g., every x seconds). Thus, if a subsequent message has not been received by x seconds after the message received in step 304, the message received in step 304 times out. The messages may therefore be considered “heartbeat” messages.

If the control element 300 concludes in step 308 that the message has timed out, then the method 300 proceeds to step 310, where the control element detects an error at the processing element. The error may be a failure that requires replication of the processing element, depending on the policy associated with the high availability group to which the processing element belongs. If an error is detected, the method 300 terminates in step 312 and a separate failure recovery technique is initiated.

Alternatively, if the control element 300 concludes in step 308 that the message has not timed out, then the method 300 proceeds to step 304 and proceeds as described above to process a subsequent message.

As discussed above, upon detecting a failure of a processing element, the primary control element will activate a replica of the failed processing element, if a replica is available. Availability of a replica may be dictated by a high availability policy associated with the high availability group to which the processing element belongs, as described above. The replica broadcasts heartbeat messages to the primary control element and the secondary control element, as described above. In addition, the primary control element notifies the secondary control element that the replica has been activated. Activation of the replica may also involve the activation of different control elements as primary and secondary control elements, as discussed above.

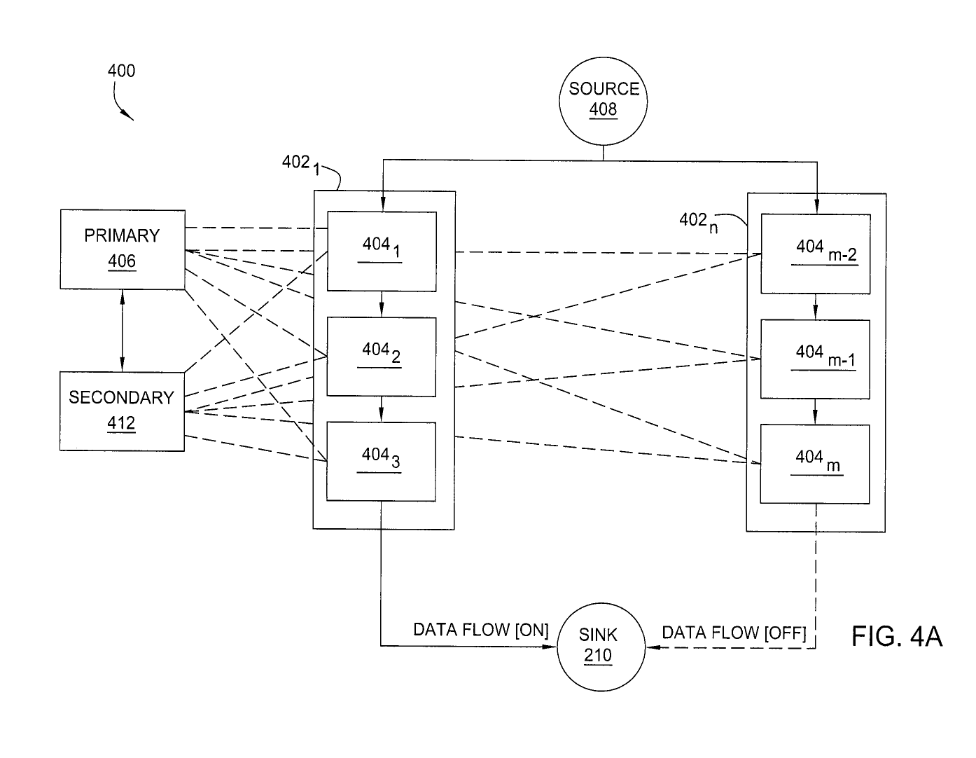

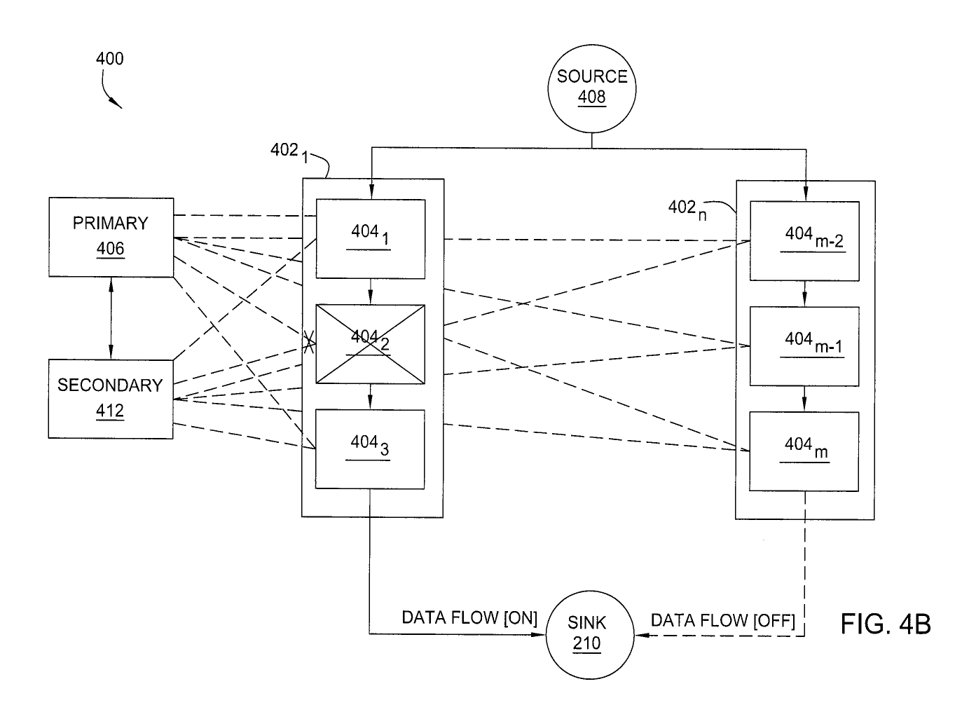

FIGS. 4A and 4B are block diagrams illustrating a second embodiment of a group 400 of operators, according to the present invention. Specifically, the group 400 of operators comprises a plurality of replicas 402₁-402ₙ (hereinafter collectively referred to as “replicas 402”) of the same set of operators. Thus, the replicated set of operators has been assigned to a high availability group as described above. The configuration of the group 400 represents an alternative to the daisy chain configuration illustrated in FIGS. 2A and 2B.

Each of the replicas 402 is connected to a common source 408 and a common sink 410. As illustrated, the replicas 402 are substantially identical: each replica 402 comprises an identical number of processing elements 404₁-404ₘ (hereinafter collectively referred to as “processing elements 404”). In addition, each of the replicas 402 is connected to both a primary control element 406 and a secondary control element 412. As illustrated in FIG. 4A, the first replica 402₁ is initially active, while the other replica 402ₙ is inactive. Thus, data flow from the first replica 402₁ to the sink 410 is set to ON, while data flow from the other replica 402ₙ to the sink 410 is set to OFF.

FIG. 4B illustrates what happens when a processing element 404 in the active replica fails. As illustrated, processing element 404₂ in the first replica 402₁ has failed. As a result, data flow from the first replica 402₁ terminates (the first replica 402₁ becomes inactive), and both the primary control element 406 and the secondary control element 412 detect this failure. As a result, the other replica 402ₙ becomes the active replica for the group 400. Thus, data flow from the other replica 402ₙ to the sink 410 is set to ON, while data flow from the first replica 402₁ is now set to OFF. Thus, the primary control element 406 continues to serve as the group's primary control element, while the secondary control element 412 continues to serve as the secondary or backup control element.

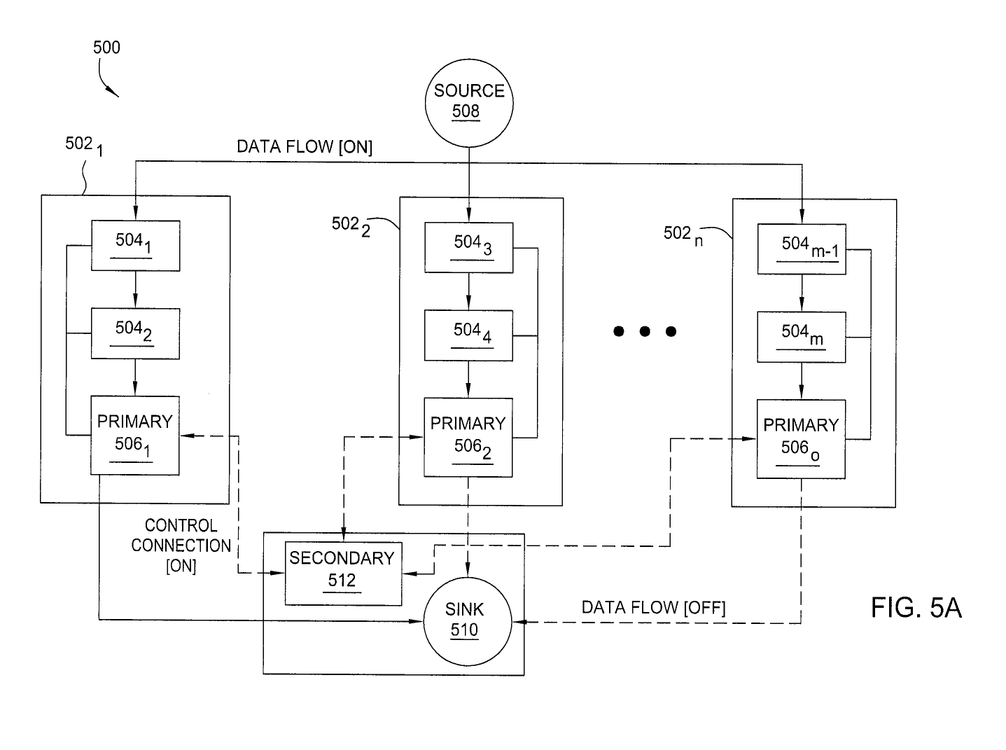

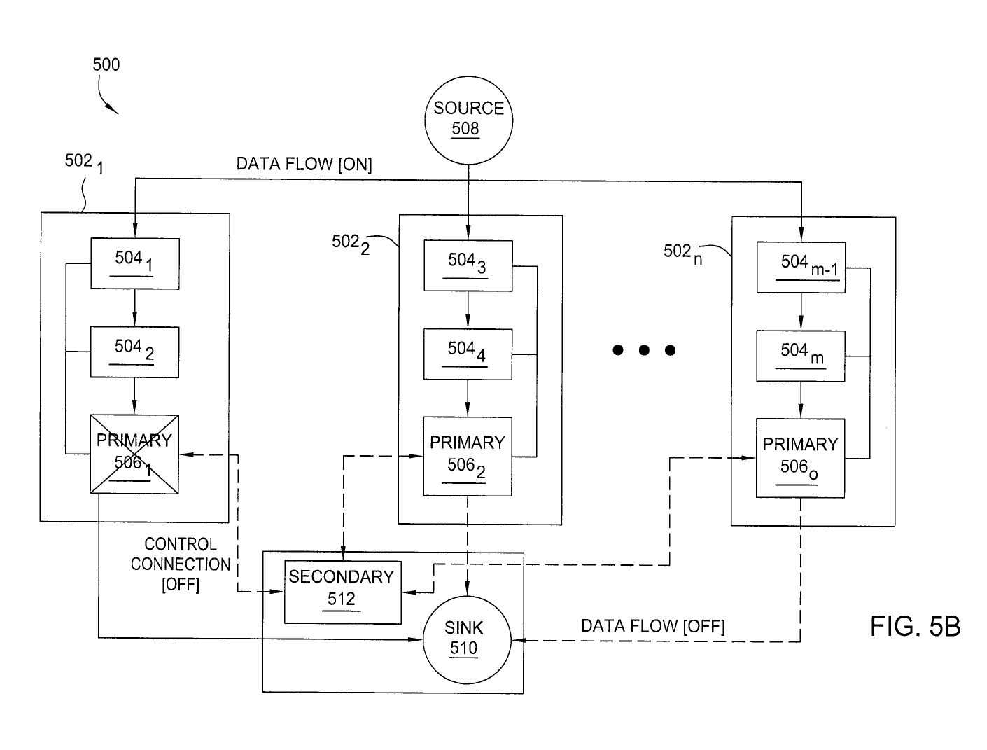

FIGS. 5A and 5B are block diagrams illustrating a third embodiment of a group 500 of operators, according to the present invention. Specifically, the group 500 of operators comprises a plurality of replicas 502₁-502ₙ (hereinafter collectively referred to as “replicas 502”) of the same set of operators. Thus, the replicated set of operators has been assigned to a high availability group as described above. The configuration of the group 500 represents an alternative to the configurations illustrated in FIGS. 2A-2B and 4A-4B.

Each of the replicas 502 is connected to a common source 508 and a common sink 510. As illustrated, the replicas 502 are substantially identical: each replica 502 comprises an identical number of processing elements 504₁-504ₘ (hereinafter collectively referred to as “processing elements 504”), as well as a respective primary control element 506₁-506ₒ (hereinafter collectively referred to as “primary control elements 506”). In addition, each of the replicas 502 is connected to a secondary control element 512. As illustrated in FIG. 5A, the first replica 502₁ is initially active, while the other replicas 502₂-502ₙ are inactive. Thus, data flow from the first replica 502₁ to the sink 510 is set to ON, while data flow from the other replicas 502₂-502ₙ to the sink 510 is set to OFF.

FIG. 5B illustrates what happens when the primary control element 506 in the active replica fails. As illustrated, primary control element 506₁ in the first replica 502₁ has failed. As a result, data flow from the first replica 502₁ terminates (the first replica 502₁ becomes inactive), and the secondary control element 512 detects this failure. As a result, the second replica 502₂ becomes the active replica for the group 500, and the secondary control element 512 notifies the primary control element 506₂ in the second replica 502₂ of this change. Thus, data flow from the second replica 502₂ to the sink 510 is set to ON, while data flow from the first replica 502₁ is now set to OFF. Thus, the primary control element 506₂ in the second replica 502₂ now serves as the group's primary control element, while the secondary control element 512 continues to serve as the secondary or backup control element.

Thus, embodiments of the present invention enable failure detection and backup for control elements as well as for processing elements.

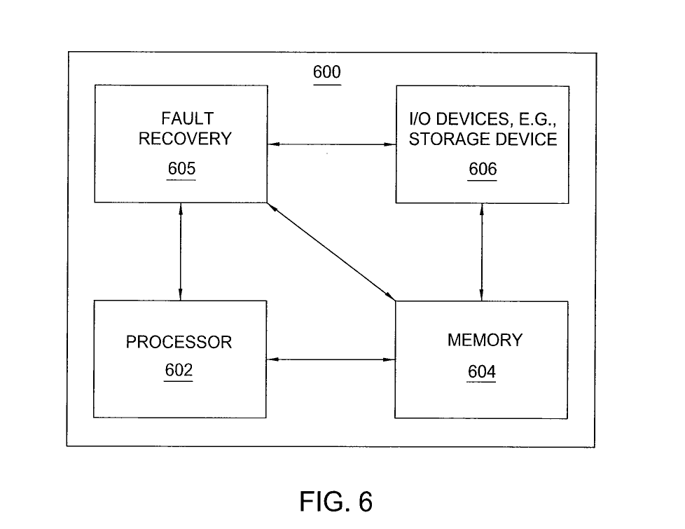

FIG. 6 is a high-level block diagram of the failure recovery method that is implemented using a general purpose computing device 600. In one embodiment, a general purpose computing device 600 comprises a processor 602, a memory 604, a failure recovery module 605 and various input/output (I/O) devices 606 such as a display, a keyboard, a mouse, a stylus, a wireless network access card, and the like. In one embodiment, at least one I/O device is a storage device (e.g., a disk drive, an optical disk drive, a floppy disk drive). It should be understood that the failure recovery module 605 can be implemented as a physical device or subsystem that is coupled to a processor through a communication channel.

Alternatively, the failure recovery module 605 can be represented by one or more software applications (or even a combination of software and hardware, e.g., using Application Specific Integrated Circuits (ASIC)), where the software is loaded from a storage medium (e.g., I/O devices 606) and operated by the processor 602 in the memory 604 of the general purpose computing device 600. Thus, in one embodiment, the failure recovery module 605 for providing fault tolerance for stream processing applications, as described herein with reference to the preceding figures, can be stored on a computer readable storage medium or carrier (e.g., RAM, magnetic or optical drive or diskette, and the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A method for providing failure recovery for an application that processes stream data, the method comprising:
using a processor to perform the steps of:
providing a plurality of operators, each of the plurality of operators comprising a software element that performs an operation on the stream data;
creating one or more groups, each of the one or more groups including a subset of the plurality of operators;
assigning a policy to each of the one or more groups, the policy comprising a definition of how the subset of the plurality of operators will function in the event of a failure; and
enforcing the policy through one or more control elements that are interconnected with the plurality of operators.

2. The method of claim 1, wherein the policy specifies a number of replicas to make of each operator in the subset of the plurality of operators.

3. The method of claim 1, wherein the policy specifies one or more fault detection mechanisms to be used by the subset of the plurality of operators.

4. The method of claim 1, wherein the policy specifies one or more fault recovery mechanisms to be used by the subset of the plurality of operators.

5. The method of claim 1, wherein the enforcing comprises:
executing at least one of: a fault detection routine and a recovery routine.

6. The method of claim 1, wherein executing a fault detection routine comprises:
receiving, at a first of the one or more control elements, a message from one of the subset of the plurality of operators;
determining whether the message has timed out in accordance with a predefined interval of time; and
detecting an error at the one of the subset of the plurality of operators, responsive to the determining.

7. The method of claim 6, further comprising:
forwarding the message, by the first of the one or more control elements, to a second of the one or more control elements, wherein the second of the one or more control elements acts as a backup for the first of the one or more control elements.

8. The method of claim 1, wherein the one or more control elements comprises:
at least one primary control element; and
at least one secondary control element that performs said enforcing responsive to failure of said at least one primary control element.

9. An apparatus comprising a computer readable storage medium containing an executable program method for providing failure recovery for an application that processes stream data, where the program performs the steps of:
providing a plurality of operators, each of the plurality of operators comprising a software element that performs an operation on the stream data;
creating one or more groups, each of the one or more groups including a subset of the plurality of operators;
assigning a policy to each of the one or more groups, the policy comprising a definition of how the subset of the plurality of operators will function in the event of a failure; and
enforcing the policy through one or more control elements that are interconnected with the plurality of operators.

10. The apparatus of claim 9, wherein the policy specifies a number of replicas to make of each operator in the subset of the plurality of operators.

11. The apparatus of claim 9, wherein the policy specifies one or more fault detection mechanisms to be used by the subset of the plurality of operators.

12. The apparatus of claim 9, wherein the policy specifies one or more fault recovery mechanisms to be used by the subset of the plurality of operators.

13. The apparatus of claim 9, wherein the enforcing comprises:
executing at least one of: a fault detection routine and a recovery routine.

14. The apparatus of claim 9, wherein executing a fault detection routine comprises:
receiving, at a first of the one or more control elements, a message from one of the subset of the plurality of operators;
determining whether the message has timed out in accordance with a predefined interval of time; and
detecting an error at the one of the subset of the plurality of operators, responsive to the determining.

15. The apparatus of claim 14, further comprising:
forwarding the message, by the first of the one or more control elements, to a second of the one or more control elements, wherein the second of the one or more control elements acts as a backup for the first of the one or more control elements.

16. The apparatus of claim 9, wherein the one or more control elements comprises:
at least one primary control element; and
at least one secondary control element that performs said enforcing responsive to failure of said at least one primary control element.

17. A stream processing system, comprising:
a plurality of interconnected operators comprising software elements that operate on incoming stream data, wherein the plurality of interconnected operators is divided into one or more groups, wherein at least one of the one or more groups comprises, for each given operator of the plurality of interconnected operators included in the at least one of the one or more groups:
at least one replica of the given operator; and
at least one control element coupled to the given operator, for enforcing a policy assigned to the given operator, where the policy comprises a definition of how the given operator will function in the event of a failure.

18. The stream processing system of claim 17, wherein the at least one control element comprises:
at least one primary control element; and
at least one secondary control element that performs said enforcing responsive to failure of said at least one primary control element.

19. The stream processing system of claim 18, wherein the at least one replica comprises a plurality of replicas, and the at least one primary control element and the at least one secondary control element are shared by all of the plurality of replicas.

20. The stream processing system of claim 18, wherein the at least one replica comprises a plurality of replicas, the at least one primary control element comprises a primary control element residing at each of the plurality of replicas, and the at least one secondary control element is shared by all of the plurality of replicas.
